(19) United States
(12) Patent Application Publication
(10) Pub. No.: US 2017/0160975 A1
(43) Pub. Date: Jun. 8, 2017

(54) DATA BUFFER ADJUSTMENT AND CONTROL METHOD THEREOF

(71) Applicant: APACER TECHNOLOGY INC., New Taipei City (TW)

(72) Inventors: Jiunn-Chang Lee, New Taipei City (TW); Chun-Han Yu, New Taipei City (TW); Feng-Chi Hsu, New Taipei City (TW)

(21) Appl. No.: 14/968,612

(22) Filed: Dec. 14, 2015

(30) Foreign Application Priority Data
Dec. 2, 2015 (TW) 104140260

(51) Int. Cl. G06F 3/06; G06F 1/28; G06F 12/08

(52) U.S. Cl. CPC G06F 3/0631; G06F 12/0802; G06F 3/0604; G06F 3/0653; G06F 3/0685; G06F 1/28

(57) ABSTRACT

A data buffer adjustment method for a solid state drive is provided. The solid state drive includes a power supplying unit, a monitoring unit, a controlling unit, a cache unit and a storage unit. An accessing electrical energy from a first power source module or a second power source module is selectively supplied to the power supplying unit. In case of power interruption, the accessing electrical energy allows data to be written from the cache memory to the storage unit. The data buffer adjustment device includes the following steps. Firstly, the monitoring unit monitors a capacity for storing electricity of the second power source module. According to the capacity for storing electricity, a size of a temporary storage space of the cache unit is dynamically adjusted. According to the size of the temporary storage space, an amount of the data is determined.

### FIELD OF THE INVENTION

The present invention relates to a data buffer adjustment device, and more particularly to a data buffer adjustment device for a solid state drive and a control method thereof.

### BACKGROUND OF THE INVENTION

Recently, a solid state drive (SDD) has been introduced into the market. The solid state drive is a data storage device. Generally, the performance of the solid state drive is over the conventional disk of hard drive. Since the solid state drive comprises plural flash memories, the transmission speed of the solid state drive is much faster than the conventional mechanical-type disk of hard drive. As known, the NAND flash memories and the controller are key components of the solid state drive. The NAND flash memories are used for storing data. The controller is used for controlling operations of the solid state drive. The NAND flash memories and the controller cooperatively perform a storing action, a transmitting action and any other appropriate operation of the solid state drive.

Moreover, the solid state drive comprises a dynamic random access memory (DRAM) as a cache unit. Before data are written into the NAND flash memory, the controller temporarily stores the data into a cache region of the dynamic random access memory. Consequently, a computer host can access the solid state device at a faster accessing speed. After a specified time period, the data are written from the cache region to the NAND flash memory. In such way, the data consistence can be retained.

However, in case that unexpected power interruption occurs, the data are erroneously written into the NAND flash memory. For solving this drawback, the solid state drive is equipped with a backup power source (e.g., a lithium battery). In case that the supplied power of the solid state drive is abnormally interrupted, the backup power source provides electricity to the controller. Consequently, the data in the cache region can be completely written into the NAND flash memory by the controller. However, the use of the backup power source still has the following drawbacks.

Firstly, the capacity for storing electricity of the backup power source is positively related to the residual use life of the backup power source. For example, if the residual use life of the lithium battery is very short, the low capacity for storing electricity of the lithium battery cannot allow the controller to completely write the data from the cache region to the NAND flash memory.

Secondly, in case that the unexpected power interruption problem occurs frequently, the lithium battery will perform the charging and discharging actions repeatedly. If the charging action has not been completely done and the capacity for storing electricity is low, the controller is unable to completely write the data from the cache region to the NAND flash memory.

Therefore, there is a need of providing a data buffer adjustment device and a control method so as to overcome the drawbacks of the conventional technologies and increase the industrial applications.

### SUMMARY OF THE INVENTION

An object of the present invention provides a data buffer adjustment device and a control method in order to overcome the drawbacks of the conventional technologies.

In accordance with an aspect of the present invention, there is provided a data buffer adjustment method for a solid state drive. The solid state drive includes a power supplying unit, a monitoring unit, a controlling unit, a cache unit and a storage unit. An accessing electrical energy from a first power source module or a second power source module is selectively supplied to the power supplying unit for allowing data to be written from the cache unit to the storage unit. The data buffer adjustment method includes the following steps. Firstly, the monitoring unit monitors a capacity for storing electricity of the second power source module. The controlling unit dynamically adjusts a size of a temporary storage space of the cache unit according to the capacity for storing electricity. The controlling unit determines an amount of the data according to the size of the temporary storage space.

In an embodiment, the data buffer adjustment method further includes a step of allowing the power supplying unit to charge the second power source module.

In an embodiment, wherein if the accessing electrical energy provided by the first power source module is interrupted, the second power source module supplies the accessing electrical energy to the power supplying unit.

In an embodiment, the first power source module is a power supply, and the second power source module is a lithium battery, a capacitor or an energy storage battery.

In an embodiment, the monitoring unit is a battery capacity calculating chip.

In an embodiment, the cache unit is a dynamic random access memory, and the storage unit is a NAND flash memory.

In accordance with another aspect of the present invention, there is provided a data buffer adjustment device. The data buffer adjustment device includes a storage unit, a cache unit, a controlling unit, a power supplying unit and a monitoring unit. The storage unit is used for storing data. The cache unit includes a temporary storage space for temporarily storing the data. The controlling unit is used for writing the data from the cache unit to the storage unit, or writing the data from the storage unit to the cache unit. An accessing electrical energy from a first power source module or a second power source module is selectively supplied to the power supplying unit so as to power the controlling unit. The monitoring unit is used for monitoring a capacity for storing electricity of the second power source module, and transmitting a value of the capacity for storing electricity to the controlling unit. The controlling unit dynamically adjusts a size of the temporary storage space according to the capacity for storing electricity. In addition, the controlling unit determines an amount of the data according to the size of the temporary storage space.

In an embodiment, the first power source module is a power supply, and the second power source module is a lithium battery, a capacitor or an energy storage battery.

In an embodiment, the monitoring unit is a battery capacity calculating chip.

In an embodiment, the cache unit is a dynamic random access memory, and the storage unit is a NAND flash memory.

In an embodiment, if the accessing electrical energy provided by the first power source module is interrupted, the second power source module supplies the accessing electrical energy to the power supplying unit.

From the above descriptions, the present invention provides a data buffer adjustment device and a control method thereof. By monitoring the capacity for storing electricity of the second power source module in real time, the controlling unit adjusts the size of the temporary storage space of the cache unit according to the capacity for storing electricity. Regardless of whether the accessing electrical energy is provided by the first power source module or the second power source module, the controlling unit can write the data from the cache unit to the storage unit. In any situation, the controlling unit can write the data from the cache unit to the NAND flash memory. Under this circumstance, the data consistence of the data in the storage unit can be effectively enhanced

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic functional block diagram illustrating a data buffer adjustment device according to an embodiment of the present invention;

FIG. 2A schematically illustrates a layout architecture of the data buffer adjustment device according to the embodiment of the present invention;

FIG. 2B schematically illustrates the relationship between the capacity for storing electricity and the size of the temporary storage space according to the embodiment of the present invention; and

FIG. 3 is a flowchart illustrating a data buffer adjustment method according to an embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. In the following embodiments and drawings, the elements irrelevant to the concepts of the present invention are omitted and not shown. For well understanding the present invention, the elements shown in the drawings are not in scale with the elements of the practical product.

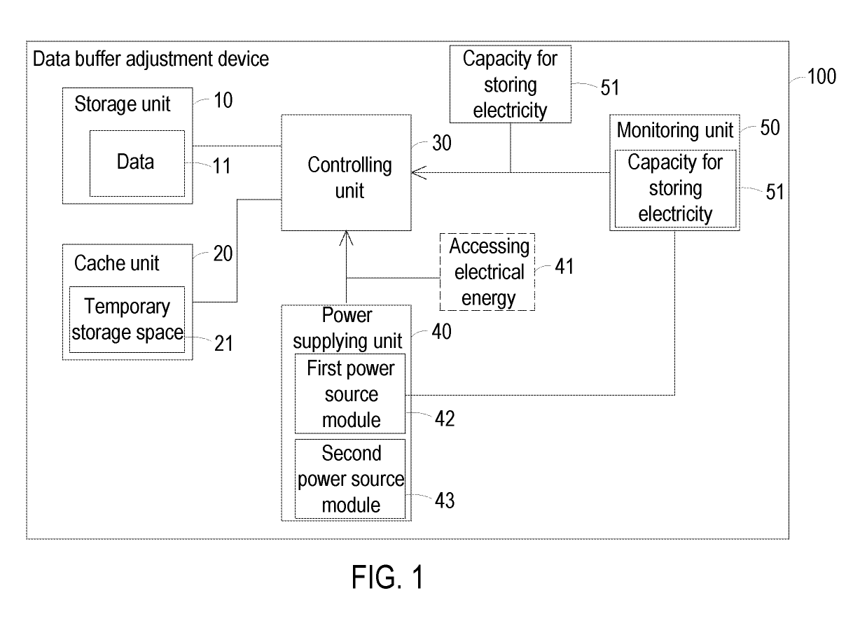

FIG. 1 is a schematic functional block diagram illustrating a data buffer adjustment device according to an embodiment of the present invention. As shown in FIG. 1, the data buffer adjustment device 100 comprises a storage unit 10, a cache unit 20, a controlling unit 30, a power supplying unit 40 and a monitoring unit 50. The storage unit 10 comprises plural NAND flash memories. The cache unit 20 is a cache region of a dynamic random access memory (DRAM). The monitoring unit 50 is a battery capacity calculating chip. The controlling unit 30 is a controller. Moreover, the controlling unit 30 is electrically connected with the storage unit 10, the cache unit 20, the power supplying unit 40 and the monitoring unit 50.

Preferably, the data buffer adjustment device 100 is a solid state drive. The data buffer adjustment device 100 is in communication with a computer host (not shown) through a data transmission wire. Moreover, a computer host transmits and writes data 11 to the data buffer adjustment device 100.

The cache unit 20 comprises a temporary storage space 21 for temporarily storing the data 11. The controlling unit 30 writes the data 11 from the cache unit 20 to the storage unit 10 at a specified time interval, so that the data 11 is stored into the storage unit 10. On the other hand, the controlling unit 30 can store the data 11 from the storage unit 10 to the cache unit 20, so that the data 11 in the cache unit 20 is accessible by the computer host.

The power supplying unit 40 provides an accessing electrical energy 41 for allowing the controlling unit 30 to perform actions. These actions include a storing action, a transmitting action, an operating action and/or any other appropriate action of the data buffer adjustment device 100. For example, while the controlling unit 30 controls the movement of the data 11 between the storage unit 10 and the cache unit 20, the accessing electrical energy 41 allows the controlling unit 30 to complete the action of moving the data 11. Moreover, the accessing electrical energy 41 is selectively provided by a first power source module 42 or a second power source module 43. For example, the first power source module 42 is a power supply of the computer host, and the second power source module 43 is a backup power source such as a lithium battery, a capacitor or an energy storage battery.

In particular, the first power source module 42 and the second power source module 43 are respectively used as a main power source and a minor power source of the data buffer adjustment device 100. In a normal working condition, the first power source module 42 provides the accessing electrical energy 41 to the controlling unit 30 and also provides electrical energy to charge the second power source module 43. In case that the accessing electrical energy 41 provided by the first power source module 42 is interrupted, the accessing electrical energy 41 is provided by the second power source module 43.

The monitoring unit 50 periodically monitors a capacity for storing electricity 51 of the second power source module 43. In addition, the information about the capacity for storing electricity 51 is transmitted from the monitoring unit 50 to the controlling unit 30. According to the capacity for storing electricity 51, the controlling unit 30 dynamically adjusts the size of the temporary storage space 21 of the cache unit 20. Moreover, according to the size of the temporary storage space 21, the amount of the data 11 written into the temporary storage space 21 is adjustable.

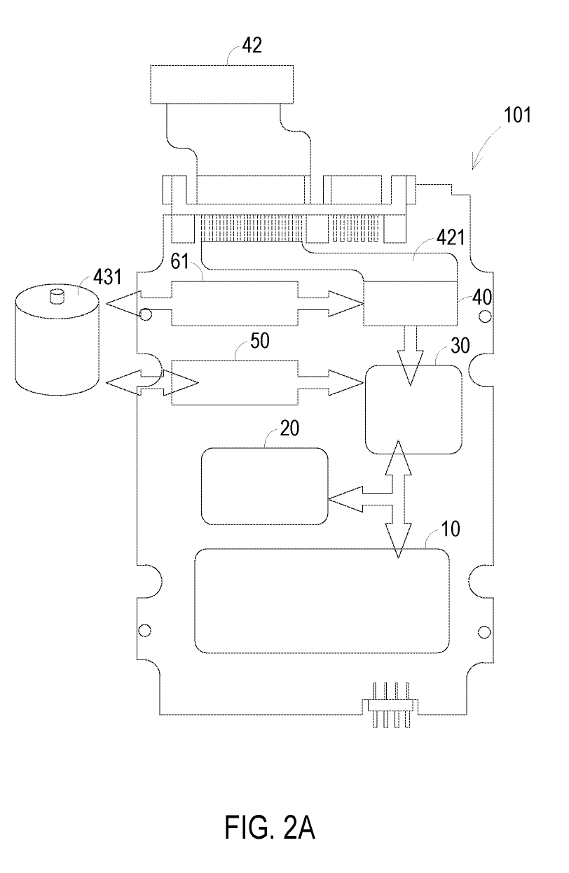

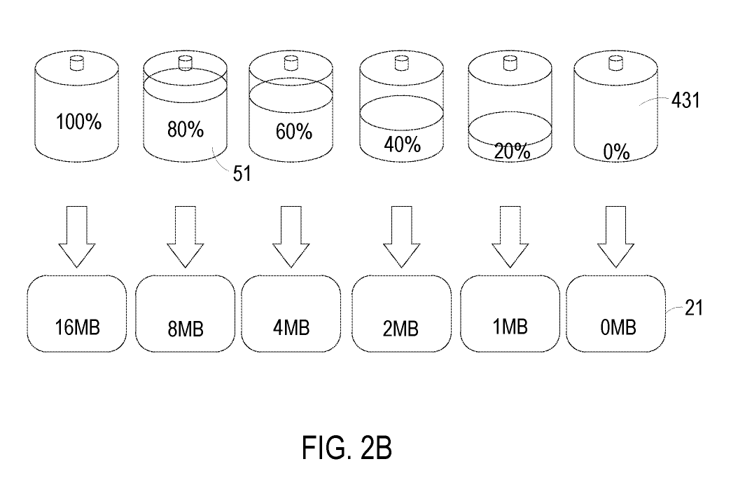

FIG. 2A schematically illustrates a layout architecture of the data buffer adjustment device according to the embodiment of the present invention. FIG. 2B schematically illustrates the relationship between the capacity for storing electricity and the size of the temporary storage space according to the embodiment of the present invention. Please refer to FIGS. 1, 2A and 2B. In this embodiment, the data buffer adjustment device 100 is a solid state drive 101. Moreover, the storage unit 10 is a NAND flash memory, the cache unit 20 is a dynamic random access memory (DRAM), the controlling unit 30 is a controller, and the monitoring unit 50 is a battery capacity calculating chip. Moreover, the controlling unit 30 is electrically connected with the storage unit 10, the cache unit 20, the power supplying unit 40 and the monitoring unit 50.

The data buffer adjustment device 100 further comprises a lithium battery 431. The lithium battery 431 is used as the second power source module 43. Moreover, the data buffer adjustment device 100 further comprises a charge/discharge managing unit 61 for controlling a charge and discharge management mechanism between the second power source module 43 and the power supplying unit 40.

In case that the solid state drive 101 is electrically connected with a computer host, the accessing electrical energy is provided from the first power source module 42. For example, the first power source module 42 is a power supply of the computer host. Moreover, the accessing electrical energy 41 is transmitted to the power supplying unit 40 through a power cable 421. Since the controlling unit 30 is powered by the accessing electrical energy 41, the controlling unit 30 can perform the storing action, the transmitting action and any other operation. At the same time, the power supplying unit 40 charges the lithium battery 431 through the charge/discharge managing unit 61.

Moreover, the monitoring unit 50 periodically monitors the capacity for storing electricity 51 of the lithium battery 431. Due to the residual use life of the lithium battery 431 or the repeated charge/discharge action of the lithium battery 431, the capacity for storing electricity 51 is changed. Consequently, the monitoring unit 50 will report or notify the capacity for storing electricity 51 to the controlling unit 30. According to the capacity for storing electricity 51, the controlling unit 30 adjusts the size of the temporary storage space 21 of the cache unit 20.

For example, the temporary storage space 21 of the cache unit 20 in the solid state drive 101 has a default size of 16 MB corresponding to 100% of the capacity for storing electricity 51. The controlling unit 30 adjusts the size of the temporary storage space 21 of the cache unit 20 according to the percentage value of the capacity for storing electricity 51. Please refer to FIG. 2B. In case that the capacity for storing electricity 51 monitored by the monitoring unit 50 is 80%, the size of the temporary storage space 21 is adjusted to 8 MB by the controlling unit 30. In case that the capacity for storing electricity 51 monitored by the monitoring unit 50 is 40%, the size of the temporary storage space 21 is adjusted to 2 MB by the controlling unit 30. The relationship between the capacity for storing electricity and the size of the temporary storage space is presented herein for purpose of illustration and description only. That is, as long as the capacity for storing electricity 51 can allow the controlling unit 30 to completely move the data 11 from the temporary storage space 21 to the storage unit 10, the reduction of the size of the temporary storage space 21 corresponding to the reduction of the capacity for storing electricity 51 is not restricted.

In particular, the action of adjusting the size of the temporary storage space 21 and the action of moving the data 11 are controlled by a firmware (not shown) of the controlling unit 30. Moreover, the firmware can averagely write the data into the pages of the NAND flash memory. Since the same page is not frequently written and read, the use life of the solid state drive is prolonged. The implementations of the firmware may be determined by the manufacturer of the solid state drive. The technologies of the firmware are well known to those skilled in the art, and are not redundantly described herein.

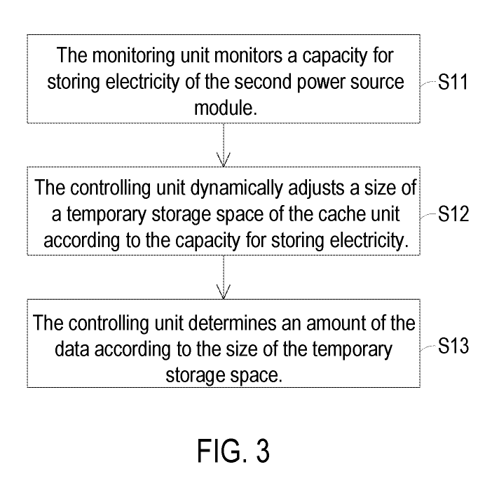

FIG. 3 is a flowchart illustrating a data buffer adjustment method according to an embodiment of the present invention. The data buffer adjustment method is applied to a solid state drive. The solid state drive includes a power supplying unit, a monitoring unit, a controlling unit, a cache unit and a storage unit. The controlling unit is electrically connected with the power supplying unit, the monitoring unit, the cache unit and the storage unit. An accessing electrical energy from a first power source module or a second power source module is selectively supplied to the power supplying unit for allowing the controlling unit to write data from the cache memory to the storage unit. The data buffer adjustment method comprises the following steps.

In a step S11, the monitoring unit monitors a capacity for storing electricity of the second power source module.

In a step S12, the controlling unit dynamically adjusts a size of a temporary storage space of the cache unit according to the capacity for storing electricity.

In a step S13, the controlling unit determines an amount of the data according to the size of the temporary storage space.

The data buffer adjustment method further comprises a step of allowing the power supplying unit to charge the second power source module. If the accessing electrical energy provided by the first power source module is interrupted, the second power source module provides the accessing electrical energy. The first power source module is a power supply, and the second power source module is a lithium battery, a capacitor or an energy storage battery. The size of the temporary storage space is adjusted according to the capacity for storing electricity. Consequently, the accessing electrical energy provided by the second power source module can allow the controlling unit to write the data from the cache unit to the storage unit.

Preferably, the monitoring unit is a battery capacity calculating chip. Moreover, the cache unit is a dynamic random access memory, and the storage unit is a NAND flash memory.

From the above descriptions, the present invention provides a data buffer adjustment device and a control method thereof. The size of the temporary storage space of the cache unit is adjusted according to the capacity for storing electricity of the second power source module. Consequently, the accessing electrical energy provided by the second power source module can allow the controlling unit to write the data from the temporary storage space to the storage unit. Under this circumstance, the data consistence of the data in the storage unit can be effectively enhanced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A data buffer adjustment method for a solid state drive, the solid state drive comprising a power supplying unit, a monitoring unit, a controlling unit, a cache unit and a storage unit, wherein an accessing electrical energy from a first power source module or a second power source module is selectively supplied to the power supplying unit for allowing data to be written from the cache unit to the storage unit, wherein the data buffer adjustment method comprises steps of:
allowing the monitoring unit to monitor a capacity for storing electricity of the second power source module;
dynamically adjusting a size of a temporary storage space of the cache unit by the controlling unit according to the capacity for storing electricity; and
determining an amount of the data by the controlling unit according to the size of the temporary storage space.

2. The data buffer adjustment method according to claim 1, further comprising a step of allowing the power supplying unit to charge the second power source module.

3. The data buffer adjustment method according to claim 1, wherein if the accessing electrical energy provided by the first power source module is interrupted, the second power source module supplies the accessing electrical energy to the power supplying unit.

4. The data buffer adjustment method according to claim 1, wherein the first power source module is a power supply, and the second power source module is a lithium battery, a capacitor or an energy storage battery.

5. The data buffer adjustment method according to claim 1, wherein the monitoring unit is a battery capacity calculating chip.

6. The data buffer adjustment method according to claim 1, wherein the cache unit is a dynamic random access memory, and the storage unit is a NAND flash memory.

7. A data buffer adjustment device, comprising:
a storage unit for storing data;
a cache unit comprising a temporary storage space for temporarily storing the data;
a controlling unit for writing the data from the cache unit to the storage unit, or writing the data from the storage unit to the cache unit;
a power supplying unit, wherein an accessing electrical energy from a first power source module or a second power source module is selectively supplied to the power supplying unit so as to power the controlling unit; and
a monitoring unit for monitoring a capacity for storing electricity of the second power source module, and transmitting a value of the capacity for storing electricity to the controlling unit,
wherein the controlling unit dynamically adjusts a size of the temporary storage space according to the capacity for storing electricity, and the controlling unit determines an amount of the data according to the size of the temporary storage space.

8. The data buffer adjustment device according to claim 7, wherein the first power source module is a power supply, and the second power source module is a lithium battery, a capacitor or an energy storage battery.

9. The data buffer adjustment device according to claim 7, wherein the monitoring unit is a battery capacity calculating chip.

10. The data buffer adjustment device according to claim 7, wherein the cache unit is a dynamic random access memory, and the storage unit is a NAND flash memory.

11. The data buffer adjustment device according to claim 7, wherein if the accessing electrical energy provided by the first power source module is interrupted, the second power source module supplies the accessing electrical energy to the power supplying unit.
